(19) United States
(12) Patent Application Publication
(10) Pub. No.: US 2024/0411595 A1
(43) Pub. Date: Dec. 12, 2024

(54) BORROWED RESOURCE ACCESS BASED ON ACCUMULATION OF RESOURCES

(71) Applicant: The Toronto-Dominion Bank, Toronto (CA)

(72) Inventors: Jonathan Joseph PRENDERGAST, West Chester, PA (US); Alexander Stuart MORRIS, Toronto (CA); Hitesh BAJAJ, Duluth, GA (US)

(73) Assignee: The Toronto-Dominion Bank, Toronto (CA)

(21) Appl. No.: 18/463,986

(22) Filed: Sep. 8, 2023

Related U.S. Application Data
(60) Provisional application No. 63/507,246, filed on Jun. 9, 2023.

(51) Int. Cl. G06F 9/50

(52) U.S. Cl. CPC G06F 9/5016

(57) ABSTRACT

A method may include: receiving an early access instruction associated with a first logical storage area, the early access instruction requesting early access to at least a portion of resources associated with a next regularly scheduled replenishment operation; determining a current borrowed resource threshold based on a measure of an amount of the next regularly scheduled replenishment operation attributable to a time period that began on a last regularly scheduled replenishment operation and ended at a current time; determining that an amount of borrowed resources required for fulfillment of the early access instruction is less than the current borrowed resource threshold; and fulfilling the early access instruction, wherein fulfillment of the early access instruction enables a computing operation to be performed that could not be performed without such fulfillment.

### TECHNICAL FIELD

The present application relates to accumulated resource access systems and, more particularly, to methods and systems which allow for early access to accumulated resources before a scheduled replenishment date.

### BACKGROUND

User accounts may receive regularly scheduled replenishments; for instance, a mobile connectivity account may have a monthly data allocation, a computing resources account may have a monthly server time allocation, or a bank account may have a regular income deposit (e.g. payroll payment). Such allocations are, in many cases, used to manage computing resources to prevent systems from being overloaded. By way of example, monthly data allocations may prevent wireless systems from being overloaded.

In some cases, systems may exist to enable a user or administrator to receive an early allocation of resources before the scheduled replenishment, i.e. an “advance” of resources. Typical early resource access systems require interoperability and integration between a number of different computing systems. For example, early resource access systems that provide early access to payroll typically require integration with a payroll computer system and a time tracking computer system so that the early resource access system may determine the number of hours that a particular employee has worked since a last transfer and to ensure that the payroll computer system accounts for any early wages provided to prevent the payroll computer system from double paying the employee. Such integrations between computing systems present numerous obstacles, particularly when many of the systems are legacy systems that do not allow for easy exposure of data.

The computing problems associated with implementing early resource access systems, have been so difficult to overcome that only large companies have typically launched such systems. Few small companies are able to accommodate the computing burden of updating legacy systems to operate with early resource access systems.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 shows a flowchart showing operations performed by a computing system in handling and early access instruction;

FIG. 6 is an example user interface indicating an error condition in accordance with an example embodiment;

FIG. 7 is an example user interface indicating an error condition in accordance with an example embodiment;

FIG. 8 shows a flowchart showing operations performed by a computing system in handling and early access instruction; and

FIG. 9 is an example user interface for inputting at early access instruction in accordance with an example embodiment.

Like reference numerals are used in the drawings to denote like elements and features.

### DETAILED DESCRIPTION OF VARIOUS EMBODIMENTS

In accordance with one aspect of the present invention, there is provided a computing system. The computing system may include a communications module. The computing system may include a processor coupled to the communications module. The computing system may include a memory coupled to the processor storing instructions that, when executed by the computing system, cause the computing system to: receive an early access instruction associated with a first logical storage area, the early access instruction requesting early access to at least a portion of resources associated with a next regularly scheduled replenishment operation; determine a current borrowed resource threshold based on a measure of an amount of the next regularly scheduled replenishment operation attributable to a time period that began on a last regularly scheduled replenishment operation and ended at a current time; determine that an amount of borrowed resources required for fulfillment of the early access instruction is less than the current borrowed resource threshold; and in response to determining that the amount of borrowed resource required for fulfillment of the early access instruction is less than the current borrowed resource threshold, fulfill the early access instruction by providing access to the amount of borrowed resources, wherein fulfillment of the early access instruction enables a computing operation to be performed that could not be performed without such fulfillment.

In some implementations, the instructions further cause the computing system to monitor for the next regularly scheduled replenishment operation and, in response to detecting the next regularly scheduled replenishment operation, perform a reversal operation to replenish the borrowed resources.

In some implementations, performing the reversal operation may include performing a data transfer associated with the first logical storage area.

In some implementations, performing the reversal operation may include applying an input output modifier during the reversal operation.

In some implementations, the instructions may further cause the computing system to: monitor for the next regularly scheduled replenishment operation; determine that a next regularly scheduled replenishment operation was not performed as scheduled; and in response to determining that the next regularly scheduled replenishment operation was not performed as scheduled, generate a notification on a device associated with the first logical storage area.

In some implementations, the notification may include a selectable option to initiate a replenishment operation.

In some implementations, the current borrowed resource threshold may be further determined based on past resource access requests.

In some implementations, the current borrowed resource threshold may be further determined by applying a modifier to the measure of an amount of the next regularly scheduled replenishment operation attributable to a time period that began on a last regularly scheduled replenishment operation and ended at a current time. The modifier may reduce the current borrowed resource threshold.

In some implementations, the instructions may further cause the computing system to provide, at a device associated with the first logical storage area, an indication of the current borrowed resource threshold for display in an interface.

In some implementations, the early access instruction may be received via the interface when the current borrowed resource threshold is displayed in the interface.

In some implementations, the early access instruction may be received via a slider interface element.

In yet another aspect, a computer-implemented method is described. The computer-implemented method may include: receiving an early access instruction associated with a first logical storage area, the early access instruction requesting early access to at least a portion of resources associated with a next regularly scheduled replenishment operation; determining a current borrowed resource threshold based on a measure of an amount of the next regularly scheduled replenishment operation attributable to a time period that began on a last regularly scheduled replenishment operation and ended at a current time; determining that an amount of borrowed resources required for fulfillment of the early access instruction is less than the current borrowed resource threshold; and in response to determining that the amount of borrowed resource required for fulfillment of the early access instruction is less than the current borrowed resource threshold, fulfilling the early access instruction by providing access to the amount of borrowed resources, wherein fulfillment of the early access instruction enables a computing operation to be performed that could not be performed without such fulfillment.

In some implementations, the method may further include: monitoring for the next regularly scheduled replenishment operation; and in response to detecting the next regularly scheduled replenishment operation, performing a reversal operation to replenish the borrowed resources.

In some implementations, performing the reversal operation may include performing a data transfer associated with the first logical storage area.

In some implementations, performing the reversal operation may include applying an input output modifier during the reversal operation.

In some implementations, the method may further include: monitoring for the next regularly scheduled replenishment operation; determining that a next regularly scheduled replenishment operation was not performed as scheduled; and in response to determining that the next regularly scheduled replenishment operation was not performed as scheduled, generating a notification on a device associated with the first logical storage area.

In some implementations, the notification may include a selectable option to initiate a replenishment operation.

In some implementations, the current borrowed resource threshold may be further determined based on past resource access requests.

In some implementations, the current borrowed resource threshold may be further determined by applying a modifier to the measure of an amount of the next regularly scheduled replenishment operation attributable to a time period that began on a last regularly scheduled replenishment operation and ended at a current time. The modifier may reduce the current borrowed resource threshold.

In some implementations, the method may further include providing, at a device associated with the first logical storage area, an indication of the current borrowed resource threshold for display in an interface.

In some implementations, the early access instruction may be received via the interface when the current borrowed resource threshold is displayed in the interface.

In some implementations, the early access instruction may be received via a slider interface element.

In accordance with another aspect of the present invention, there is provided a non-transitory computer-readable storage medium storing instructions that when executed by a processor of a computing system cause the computing system to perform a method described herein. In one example, the computer-readable storage medium may store instructions that, when executed by a computing system, cause the computing system to: . . .

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term account or user account may be used interchangeably with “logical storage area” or “record” or “record in a database.”

In the present application, the terms “transferor” and “transferee” may be used interchangeably with “sender” and “recipient”, respectively, in the context of describing transfers of resources. In some cases, the terms “payor” or “payee” may be used in the example of monetary resources.

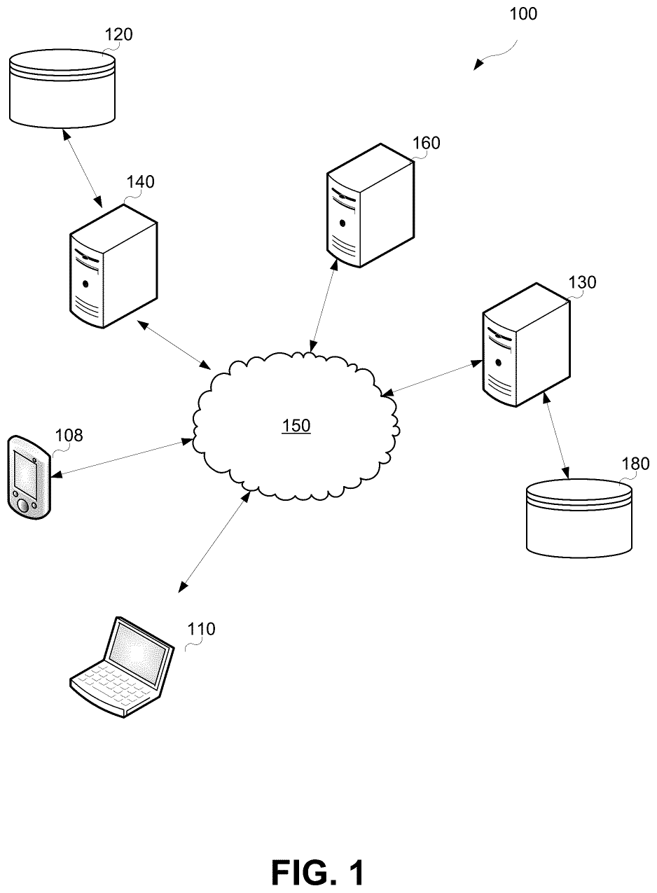

FIG. 1 is a block diagram illustrating an operating environment of an example embodiment. Various components cooperate to provide a system 100 which may be used, for example, to perform an operation. As shown, the system 100 may include a first device 108. The first device 108 may be associated with a first logical storage area. The system 100 may include a second device 110. The second device 110 may be associated with a second logical storage area. The system 100 may include a first database management system 130. The first database management system 130 may manage the first logical storage area. The system 100 may also include a second database management system 140. The second database management system 140 may manage the second logical storage area.

Any two or more of first device 108, the second device 110, the first database management system 130 and the second database management system 140 may be coupled to one another through a network 150. The network 150 may include a public network, such as the Internet, and/or a private network.

The first device 108 is a computing device that may be associated with an object. The object may be or include an entity, such as a person or business. The object may be or include a system, such as a server or other type of computing system. The object may be referred to as an accountholder or a logical storage area holder, in some implementations. The first device 108 may be associated with an object that is also associated with the first logical storage area. The first logical storage area may be an account or other storage area at one of the first database management system 130 or the second database management system 140.

In one example, the object may be associated with a mobile connectivity account. That is, the first logical storage area may be a mobile connectivity account. The mobile connectivity account may receive a periodic replenishment of resources. For example, the mobile connectivity account may receive, from a mobile services system, a periodic replenishment of a data allocation or some other allocation. By way of example, the mobile connectivity account may have a monthly data allocation. The data allocation may enable the first device 108 to send and receive data. By way of example, the data allocation may be a wireless data allocation. The data allocation may be reflected by a balance and, when the balance falls to zero, no more data may be used until the balance is increased above zero. The data allocation may be specified in data units such as, for example, megabytes, gigabytes, etc.

In another example, the first logical storage area may be or represent a computing resource account. The computing resource account may track computing resources that are to be made available to a particular object, such as a particular entity or computing system. The computing resources may be or include, for example, processor cycles, memory, network resources, server resources, hosting resources, or computing resources of another type. The computing resource account may receive, from a computing resource providing system, a periodic replenishment of a computing resource allocation. The computing resource allocation may, for example, enable the first device 108 to use an associated computing resource at a server or other system. The computing resource allocation may be reflected by a balance and, when the balance falls to zero, no more computing resources may be used (e.g., by the first device 108) until the balance is increased above zero. By way of example, it may be that the computing resource account is periodically allocated resource units reflecting an amount of server time, processor cycles, memory, network bandwidth, or another computing resource that are available to an object associated with the computing resource account.

In yet another example, the first logical storage area may be or represent a streaming service account. The streaming service account may track streaming resources that are to be made available to a particular object, such as a particular entity or computing system (such as the first device 108), by a streaming system. The streaming services may be associated with any one or both of streaming video (e.g., movies, television episodes, and/or clips) and streaming audio (e.g., songs and/or podcasts). A streaming service may periodically allocate streaming resources to the streaming service account. Such an allocation may be made by updating a balance associated with the account. The balance may reflect an amount of resource units available to the account. The resource units may represent, for example, a number of time units, such as minutes, a number of media units, such as a number of episodes, songs, podcasts, movies, etc., or a number of data units such as a number of bytes, megabytes or gigabytes. When the balance falls to zero, no more streaming resources may be used in association with the streaming service account until the balance is increased above zero.

In yet another example, the first logical storage area may be or represent a bank account. The bank account may periodically receive a replenishment of funds based on a transfer that may be initiated at another system, such as at a payroll system. A balance may indicate an amount of funds held in the account and, when the balance falls to zero, operations that requires the use of funds, such as transfer operations, may not be performed using the bank account. In some implementations, the object associated with the first logical storage area may be an entity such as a user or client who is an employee of a first employer and who has a record in a database associated with and/or provided by the first database management system 130.

The second logical storage area may be of the same or a similar type as the first logical storage area. In at least some implementations, the second logical storage area may be associated with an object such as an entity and/or system. The second logical storage area may, for example, be associated with a replenishment system. The replenishment system may, for example, perform a replenishment operation to periodically replenish the first logical storage area. The second logical storage area may be a storage area, such as an account, at the second database management system 140. The replenishment operation may involve a transfer of resource units.

The second device 110 may be a computing device that may be associated with an object, such as an entity, such as the employer of the employee. The employer may have a record in a database associated with and provided by the second database management system 140. The records may also be referred to herein as logical storage areas.

The records and/or logical storage areas may be or represent account data. The records may include data of various types and the nature of the data will depend on the nature of the first database management system 130 and the second database management system 140. By way of example, the records may reflect a resource balance and/or a transfer history.

By way of example, in some implementations, the first database management system 130 and the second database management system 140 may maintain user accounts and a record in the database may be or represent an account. The record may include or represent one or more resources. The resources may, for example, include computing resources, such as memory or processor cycles, bandwidth, data or memory usage, etc. By way of further example, the resources may include stored value, such as fiat currency, which may be represented in one or more databases. The resources may, in some implementations, include streaming data such as streaming video and/or audio. The resources may, in some implementations, be or include documents and/or other data stored by or on behalf of a user. By way of example, in an implementation, a user account may include documents or data uploaded by the user. Such documents and/or data may include, for example, any one or more of: images such as photographs, text-based documents, documents prepared according to a standardized file format, such as portable document format (PDF) documents, user preferences, digital identity data such as stored identity information or documentation, or other types of documents and/or data. For example, in an implementation, the first database management system 130 and/or the second database management system 140 may track, manage, maintain, and/or provide resources to associated entities. The resources may, for example, be computing resources, such as memory or processor cycles. By way of further example, the resources may include stored value, such as fiat currency, which may be represented in a database.

As illustrated, the second database management system 140 may be coupled to a second database 120, which may be provided in secure storage. The secure storage may be provided internally within the second database management system 140 or externally. The secure storage may, for example, be provided remotely from the second database management system 140. For example, the secure storage may include one or more data centers. The data centers may, for example, store data with bank-grade security.

The second database 120 may include records associated with a plurality of entities. For example, the records may be for a plurality of accounts (e.g., a plurality of logical storage areas) and at least some of the records may define a quantity of resources. For example, the entity that is associated with the second device 110, such as the employer, may be associated with an account having one or more records in the second database 120. The records may reflect a quantity of stored resources that are associated with the entity. Such resources may include owned resources and, in at least some embodiments, borrowed resources. The resources that are associated with an entity may be grouped into various buckets. Some such buckets may, for example, represent individual bank accounts. For example, an entity may be associated with one or more bank accounts. At least some of the resources may be borrowed resources. The borrowed resources may, for example, represent an amount of credit that is available to the entity. The entity that is associated with the second device 110 and associated with the second logical storage area, such as the account, may be a customer of a financial institution which operates or manages the second database management system 140. The term balance, as used herein, may refer to both owned resource balances and borrowed resource balances such as a credit limit.

The first database management system 130 and the second database management system 140 may be operated by different entities. That is, the first database management system 130 may be associated with a first system operator and the second database management system 140 may be associated with a second system operator who is different than the first system operator. The first database management system 130 may be, for example, associated with a financial institution server that is associated with a different financial institution than the second database management system 140. These database management system 130, 140 may maintain different customer accounts, such as different financial accounts. That is, the second database management system 140 may maintain a second database 120 that includes various data records. A data record may, for example, reflect an amount of value stored in a particular account associated with a user.

The first database management system 130 may include or be connected with a first database 180 that operates similar to the second database 120 that is provided by or associated with the second database management system 140. One of the accounts maintained by the first database management system 130 may be associated with an employee of the employer having an account with the second database management system 140.

The first database management system 130 and/or the second database management system 140 may store other data instead of or in addition to financial account data. By way of example, as noted above, in some implementations, the first database management system 130 and the second database management system 140 may manage computing resources such as memory and/or processor cycles which may be used by an associated device, such as the first device 108 and/or second device 110. The records may, for example, associate a particular entity with particular resources. For example, the records may entitle a particular entity exclusive or shared use of a computing resource. The database management systems 130, 140 may communicate with one another in order to send and receive request-to-transfer messages that transfer use of a resource from a record maintained by the second database management system 140 to a record maintained by the first database management system 130, or vice versa.

In another example, the database management systems 130, 140 may act as cloud-based storage and may store files, such as documents for various entities. The second database management system 140 may, in accordance with instructions received from an entity associated with a document, transfer that document to another entity having a record at the first database management system 130. By way of example, the document may be a media file, such as an electronic book, video file or audio file, having digital rights management (DRM) which only permits the document to be transferred if exclusive use of the document is transferred (i.e., if the transfer is performed such that the transferor is no longer able to use the document after the transfer). The database management systems 130, 140 may communicate with one another in order to transfer the document in accordance with instructions received from the second device 110. For example, a transfer may be made from an account associated with the second device 110, such as the second logical storage area, to an account associated with the first device 108, such as the first logical storage area.

The first device 108 and the second device 110 may each take a variety of forms such as a smartphone, a tablet computer, a wearable computer such as a head-mounted display or smartwatch, a laptop or desktop computer, or a computing device of another type. The first database management system 130 and/or the second database management system 140 may be referred to as first and second computing devices and/or first and second computing systems respectively and may also be referred to as first and second servers, respectively. The first device 108 and the second device 110 may each be referred to as one or more of a client device, an electronic device, a computing device and a computing system.

The network 150 is a computer network. In some embodiments, the network 150 may be an internetwork such as may be formed of one or more interconnected computer networks. For example, the network 150 may be or may include an Ethernet network, an asynchronous transfer mode (ATM) network, a wireless network, a telecommunications network, or the like.

The first database management system 130 may be configured to communicate with other servers, such as the second database management system 140 using one or more communication protocols, which may also be referred to as transfer protocols or transfer rails.

In at least some embodiments, a transfer rail server 160 may be configured to facilitate a transfer from one record, such as a second logical storage area, to another record, such as a first logical storage area, according to a first transfer protocol. The first record may be a data record maintained by the second database management system 140 and the second record may be a data record maintained by a server associated with a different system operator than the second database management system 140 (e.g., such as the first database management system 130). The transfer rail server 160 may operate as an intermediary between the first database management system 130 and the second database management system 140.

One or more of the transfer protocols may not require the use of a transfer rail server. For example, one or more of the transfer protocols may operate through the exchange of messages directly between the first database management system 130 and the second database management system 140. Such messages may be exchanged through the network 150.

The first device 108, the second device 110, the first database management system 130, the second database management system 140, and the transfer rail server 160 may be in geographically disparate locations. Put differently, the first device 108, the second device 110, the first database management system 130, the second database management system 140, and the transfer rail server 160 may be remote from one another. Two or more of the first device 108, the second device 110, the first database management system 130, the second database management system 140, and the transfer rail server 160 may communicate via the network 150.

In at least some implementations, a replenishment operation that replenishes one or more resources associated with a logical storage area may be or may represent a transfer. For example, a replenishment operation may include a transfer from a second logical storage area to a first logical storage area. The transfer may be of a balance, or a portion thereof.

The first and second databases 180, 120 may store account data. That is, the first and second databases 180, 120 may store data that is associated with various accounts. In at least some implementations, each record/logical storage area in the first and second databases 180, 120 may be associated with a particular one of these accounts.

The first database management system 130 and the second database management system 140 are computing systems and may be referred to, for example, as a first computing system and a second computing system respectively.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

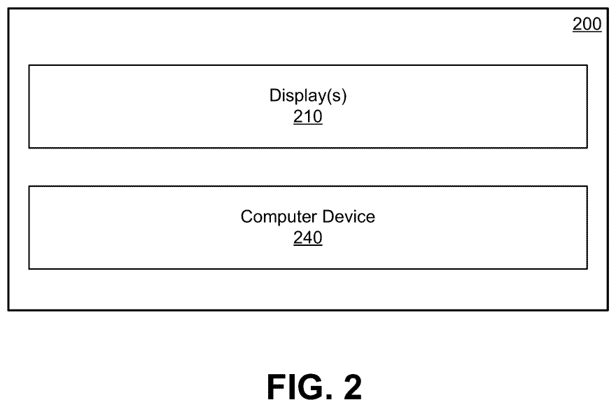

FIG. 2 is a simplified schematic diagram showing components of an exemplary computing device 200. The computing device 200 may include modules including, as illustrated, for example, one or more displays 210 and a computer device 240. The computing device 200 may be or include one of the systems of FIG. 1. For example, in some implementations, the computing device 200 may operate as the first device 108. Another computing device 200 may operate as the second device 110. Another computing device 200 may operate as the first database management system 130. Another computing device 200 may operate as the second database management system 140.

The one or more displays 210 may be or include a display module. The one or more displays 210 are used to display screens of a graphical user interface that may be used, for example, to communicate with the first database management system 130 (FIG. 1) and/or the second database management system 140 (FIG. 1). The one or more displays 210 may be internal displays of the computing device 200 (e.g., disposed within a body of the computing device).

The computer device 240 is in communication with the one or more displays 210. The computer device 240 may be or may include a processor which is coupled to the one or more displays 210.

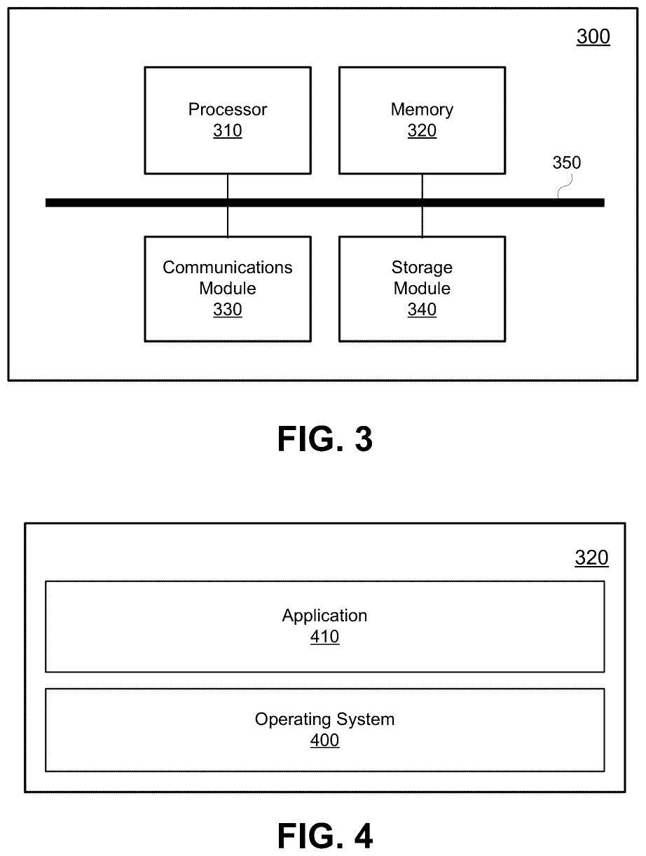

Referring now to FIG. 3, a high-level operation diagram of an example computer device 300 is shown. In some embodiments, the computer device 300 may be exemplary of the computer device 240 (FIG. 2), the first database management system 130, first device 108, the second device 110 and/or the second database management system 140.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Where the example computer device 300 functions as the first database management system 130 of FIG. 1, the storage module 340 may allow the example computing device 300 to access the secure data in the first database 180. Likewise, where the example computer device 300 functions as the second database management system 140 of FIG. 1, the storage module 340 may allow the example computing device 300 to access the secure data in the second database 120.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the first device 108, the second device 110, the first database management system 130, and/or the second database management system 140.

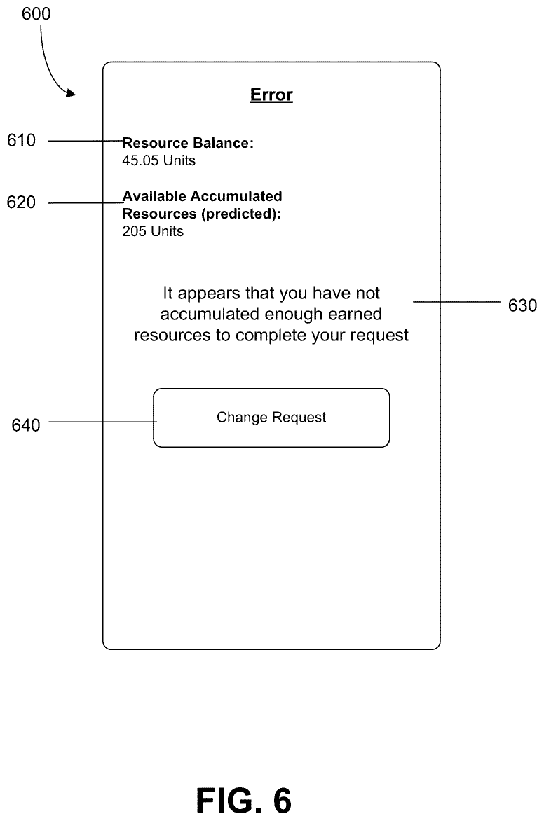

While a single application 410 is illustrated in FIG. 3, in operation the memory 320 may include more than one application 410 and different applications 410 may perform different operations. For example, in at least some embodiments in which the computer device 300 is functioning as the first device 108, the second device 110, the applications 410 may include a resource management application. The resource management application may be configured for secure communications with the first database management system 130 and may provide various functions such as, for example, the ability to display data in a record in the first database 180. In some implementations, the resource management application may be a banking application which may, for example, be configured to display a quantum of value in one or more data records (e.g., display balances), configure or request that operations such as transfers of value (e.g., bill payments, email money transfers and other transfers) be performed, and perform other account management functions. The resource management application may, in at least some implementations, configure the first device 108 to display user interfaces 600, 700, 900 of the type described above with reference to FIGS. 6, 7 and 9.

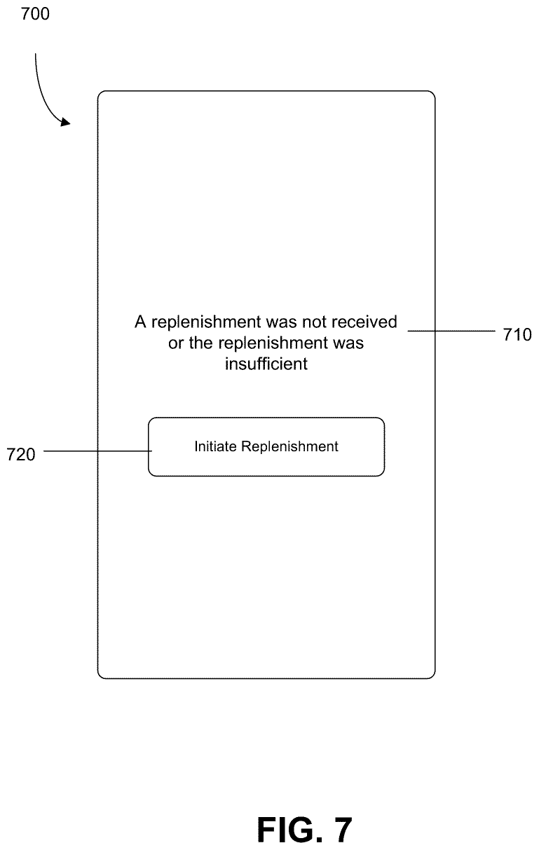

By way of further example, in at least some embodiments in which the computer device 300 functions as the first device 108 or the second device 110, the applications 410 may include a web browser, which may also be referred to as an Internet browser. In at least some such embodiments, the first database management system 130 may be or include a web server that may serve one or more of the interfaces described herein. The web server may cooperate with the web browser and may serve as an interface when the interface is requested through the web browser. For example, the web browser may serve as a resource management interface such as a mobile banking interface. The resource management interface may provide various resource management functions such as, for example, the ability to display a balance of resources defined in one or more data records (e.g., to display balances), configure or request that operations such as transfers of value (e.g., bill payments and other transfers) be performed, and other account management functions. Accordingly, in at least some implementations, the user interfaces 600, 700, 900 of FIGS. 6, 7 and/or 9 may be displayed in a web browser.

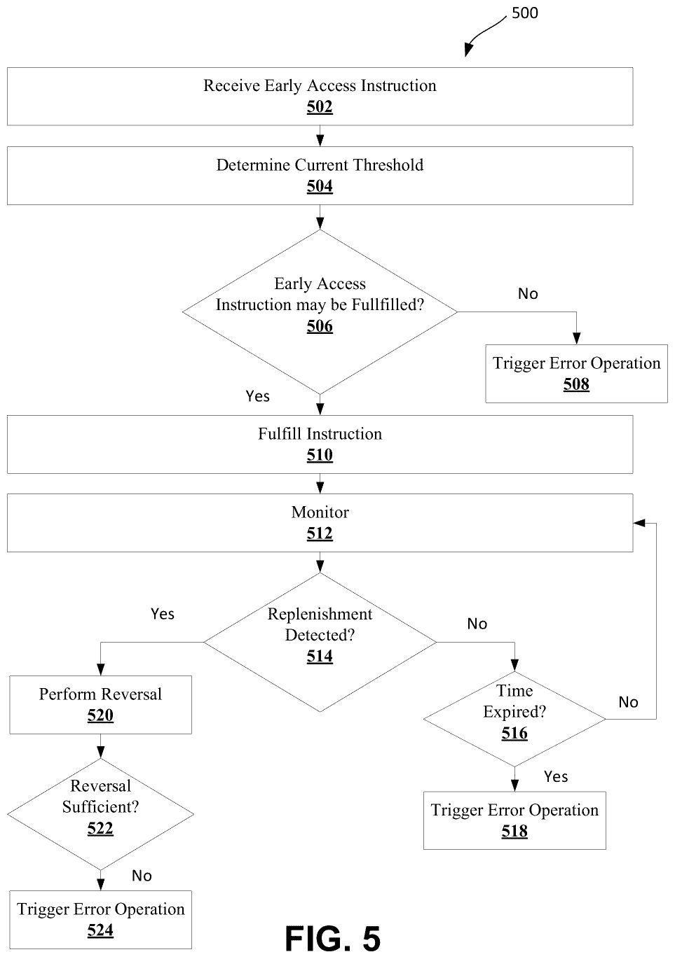

Reference is now made to FIG. 5, which shows, in flowchart form, an example method 500 of providing early access to an accumulated resource. The method 500 may be implemented by a computing system such as the first database management system 130 of FIG. 1. For example, a software module may be configured to cause the first database management system 130 of FIG. 1 to implement the method 500. The method 500 may be performed, for example, by the processor 310 (FIG. 3) of a computing device 300 executing software comprising instructions such as may be stored in the memory 320 of the computing device 300. More particularly, processor-executable instructions may, when executed, configure a processor 310 of a computing system such as the first database management system 130 to perform all or parts of the method 500 or a portion thereof.

In performing the method 500, the first database management system 130 may cooperate with other systems and devices such as, for example, a first device 108 (FIG. 1) and/or a second database management system 140. Each of these devices may be configured with processor-executable instructions which cause such devices to perform methods which cooperate with the method 500. Accordingly, operations that are referred to below as being performed by the first device 108 may be included in a method which a processor of the first device 108 may perform. Similarly, operations that are referred to below as being performed by the first database management system 130 may be included in a method which a processor of the first database management system 130 may perform. Further, in performing such a method, the first database management system 130 may cooperate with the second device 110 and/or the second database management system 140 which may perform one or more other methods. Such methods may include any operations described herein as being performed by the such devices. Further, it is contemplated that a method may be performed by a system that includes two or more of the first database management system 130, the second database management system 140, the first device 108 and the second device 110, such that the method may include operations performed by multiple devices.

At an operation 502 of the method 500, the computing system performing the method may receive an early access instruction. The received early access instruction may be associated with a first logical storage area. The early access instruction may request early access to at least a portion of resources associated with a next regularly scheduled replenishment operation that is expected to replenish resources in the first logical storage area.

The early access instruction may be received at a device associated with the first logical storage area. For example, the early access instruction may be received at a first device 108. The first device 108 may be associated with an object, such as an entity that owns or is otherwise associated with the first logical storage area. The early access instruction may be received via an interface displayed on the first device 108. By way of example, the interface may be provided in or by a resource management application.

In some instances, the method 500 may include an operation of detecting a defined condition and notifying the first device 108 in response to detecting the defined condition. Then, the early access instruction may be received in response to the notification. By way of example, the defined condition may be a condition that is based on a threshold. For example, if a balance in the first logical storage area falls below a threshold, then the notification may be triggered.

The resources for which the early access instruction requests access may be resources of a type described above. By way of example, the resources may be or represent computing resources, such as processor cycles, memory, network resources, server resources, hosting resources, or computing resources of another type. By way of further example, the resources may be or represent streaming resources such as audio or video resources. By way of yet a further example, the resources may be or represent connectivity resources, such as a data allocation. By way of yet a further example, the resources may be or represent a storage of value, such as fiat or cryptocurrency resources.

The next regularly scheduled replenishment operation may be a replenishment operation that is scheduled to occur and/or that is expected to be scheduled to occur. In one implementation, the regularly scheduled replenishment operation may represent a scheduled release of resources. By way of example, in one implementations, the next regularly scheduled replenishment operation may be or represent a payroll processing operation. By way of example, it may reflect a next pay date for a scheduled payroll run. As noted above, the resources may be of other types and so the replenishment operations may take other forms.

The replenishment operation is, in at least some implementations, regularly scheduled in that it is configured to be performed at a defined interval. The interval may be, for example, daily, weekly, bi-weekly, monthly, yearly, etc.

The early access instruction that is received at the operation 502 may be a direct instruction or an implicit instruction. A direct instruction is an instruction that specifically requests early access to an accumulated, accrued or earned resource. The direct instruction may specify an amount associated with the instruction. An indirect instruction is an instruction that does not directly request such early access. Rather, the indirect instruction may be received when an instruction to perform a computing operation in association with the first logical storage is received at the first database management system 130 and where the computing operation cannot be completed without early access to the accumulated, accrued or earned resource. For example, it may be that a first device 108 inputs an instruction to perform a computing operation that requires an amount of resources that is not available based on the amount of resources currently reflected in the first logical storage area. In such circumstances, the first database management system 130 may determine that an early access instruction has been received.

Referring still to FIG. 5, at an operation 504, the first database management system 130 may determine a current borrowed resource threshold. The current borrowed resource threshold may be determined based on a measure of an amount of the next regularly scheduled replenishment operation attributable to a time period that began on a last regularly scheduled replenishment operation and ended at a current time. That is, the current borrowed resource threshold may be determined by determining how much of the resources that will be provided in the next regularly scheduled replenishment operation are attributable to a time period that has already occurred. Put differently, the first database management system 130 may determine how much of the resources have accrued but not yet been transferred to the first logical storage area and it may determine the current borrowed resource threshold based on the amount of accrued resources.

In some implementations, the first database management system 130 may determine the current borrowed resource threshold as an estimate. For example, the estimate may be a pro-rata operation which assumes that resources are earned and/or accrued linearly. By way of example, if resources are replenished monthly, then the first database management system 130 may assume that, for each day of the month, the amount of resources that are accrued after each day is based on an amount of a monthly replenishment divided by the number of days in the month. Thus, the first database management system 130 may determine the amount of accumulated or accrued resources at the operation 504 based on the length of time between replenishment operations, and based on the amount of time that has elapsed since the last replenishment operation, and based on the amount of resources that are expected to be provided to the first logical storage area at the next regularly-scheduled replenishment operation. In this way, the current borrowed resource threshold may represent the portion of the resources associated with a next regularly-scheduled replenishment operation that have been accumulated, accrued or earned at the current time.

As noted above, the current borrowed resource threshold may be determined as an estimate that is based on the amount of resources that are expected to be provided to the first logical storage area at the next regularly-scheduled replenishment operation. This amount may be determined based on an amount of past regularly-scheduled replenishment operations. By way of example, the amount of resources that are expected to be provided to the first logical storage area at the next regularly-scheduled replenishment operation may be determined to be the amount of a most-recent regularly-scheduled replenishment operation. By way of further example, in some implementations, the amount of resources that are expected to be provided to the first logical storage area at the next regularly-scheduled replenishment operation may be determined to be an average of the amounts of a defined number of recent regularly-scheduled replenishment operations.

The current borrowed resource threshold may be an up-to-date threshold that is determined based on a current date and/or time. The current borrowed resource threshold may be determined, based in part, on the date of a last regularly-scheduled replenishment operation. This date may be identified, for example, from a log or other data structure stored in memory. The current borrowed resource threshold may be determined, based in part, on the date of a next regularly-scheduled replenishment operation. This date may be identified by the first database management system 130 by identifying a pattern of past regularly-scheduled replenishment operations. The dates of past regularly-scheduled replenishment operations may be identified from a log or other data structure stored in memory.

The regularly-scheduled replenishment operations may be operations that are initiated at a second database management system 140. The second database management system 140 may, for example, perform the regularly-scheduled replenishment operations by transferring a resource from a second logical storage area to the first logical storage area. This transfer may be a transfer of a balance or a portion thereof. The second database management system 140 and/or the second logical storage area may be associated with, for example, a computing resource providing server, a data providing server and/or a payroll processing server. In at least some implementations in which the second database management system 140 and/or the second logical storage area is associated with a payroll processing server, the method 500 may represent an earned wage access method.

The current borrowed resource threshold may be identified by the first database management system 130 without having to poll or query the second database management system 140 or a server or system such as a payroll processing server, time tracking server or other resource replenishment server that is associated with the second database management system 140 and/or the second logical storage area. Conveniently, this may allow the first database management system 140 to process early access instructions without having to interoperate with other systems such as the payroll processing server or other resource replenishment server. This may allow the first database management system 130 to process the early access instruction and to fulfill such an instruction without having to cooperate with the second database management system 140 or a server or system such as a payroll processing server or other resource replenishment server that is associated with the second database management system 140 and/or the second logical storage area. This may reduce the computing complexity and burden of the early access system and method. Existing early access systems typically require computing integrations between a first database management system 130, such as a financial institution system, and a server or system that is associated with the second database management system 140 and/or the second logical storage area, such as a payroll processing server or other resource replenishment server. Such integrations require great computing complexity and, for this reason, early access systems are seldom used.

In other implementations, the current borrowed resource threshold may be determined by the first database management system 130 based on a poll or query to the second database management system 140 or a server or system such as a payroll processing server or other resource replenishment server that is associated with the second database management system 140 and/or the second logical storage area.

The current borrowed resource threshold may be determined based on other data or inputs. For example, in some implementations, the current borrowed resource threshold may be determined to be less than the amount of resources that have accrued, accumulated or been earned since a last regularly-scheduled replenishment operation. A buffer or modifier may be defined and the buffer or modifier may prevent a complete draw-down of all accrued, accumulated or earned resources. For example, the current borrowed resource threshold may be determined by applying a modifier to the measure of an amount of the next regularly scheduled replenishment operation attributable to a time period that began on a last regularly scheduled replenishment operation and ended at a current time. The modifier reduces the current borrowed resource threshold. The modifier may be applied as a mathematical operation such as a subtraction, division or multiplication. By way of example, in one implementation, the modifier may be a number that is less than one and the number may be multiplied by the measure of the amount of the next regularly scheduled replenishment operation attributable to the time period that began on the last regularly scheduled replenishment operation and ended at the current time. By way of example, in one implementation, the modifier may be 0.8 and it may be used to identify a current borrowed resource threshold that is 80% of the accrued, accumulated or earned resources.

In some implementations, the current borrowed resource threshold may be determined to set aside resources for scheduled or expected resource access requests. For example, the current borrowed resource threshold may be determined based on past resource access requests.

The early access instruction received at the operation 502 may be a request to pull resources, or to simulate the pull of resources, rather than waiting until a next push of resources. The early access instruction received at the operation 502 may, in at least some implementations, specify an amount of resources. The amount of resources may be an amount of resources that are requested for early access; that is, for access immediately rather than at the next regularly-scheduled replenishment operation.

At the operation 506, the first database management system 130 may determine whether the early access instruction may be fulfilled. That is, the first database management system 130 may determine whether there are sufficient accrued, accumulated or earned resources to complete the early access instruction. The early access instruction may also be referred to as an early access request. Whether there are sufficient resources may depend on the amount of resources defined in the early access instruction and/or on the current borrowed resource threshold determined at the operation 504 and/or based on an amount of owned resources defined in the first logical storage area. For example, the first database management system 130 may compare the amount of borrowed resources required for fulfillment of the early access instruction to the current borrowed resource threshold determined at the operation 504. If the current borrowed resource threshold is greater than or equal to the amount of borrowed resources required for fulfillment, then the first database management system 130 may determine that the early access instruction may be fulfilled. If, however, the current borrowed resource threshold is less than the amount of borrowed resources required for fulfillment, then the first database management system 130 may determine that the early access instruction may not be fulfilled.

A borrowed resource may be a resource that is advanced or otherwise provided to the first logical storage area and/or an object associated with the first logical storage area. A borrowed resource may be a resource that is advanced or provided by the first database management system 130 without any involvement of the second database management system 140. That is, the borrowed resource may effectively operate as a loaned resource. The resource that is loaned or advanced may be provided by the first database management system 130.

If the first database management system 130 determines that the early access instruction may not be fulfilled at the operation 506, then it may proceed to an operation 508 at which it may trigger an error operation 508. Reference will briefly be made to FIG. 6 which illustrates an example interface 600 that may be displayed as part of the error operation 508. The interface 600 includes a message 630 indicating that the accumulated, accrued or earned resources are insufficient to complete the request. The interface 600 may identify a balance 610 in the first logical storage area. The interface 600 may identify an amount 620 of accrued, accumulated or earned resources. The interface 600 may, in some implementations, include a selectable option 640 to send a revised early access instruction to the first database management system 130. The revised early access instruction may be an instruction specifying a lesser amount than the early access instruction received at the operation 502. The revised early access instruction may be received by the first database management system 130 at a further iteration of the operation 502 and the method 500 may continue at a further iteration of the operation 504 and/or the operation 506.

Returning again to FIG. 5, if the first database management system 130 determines that the early access instruction may be fulfilled at the operation 506, then it may proceed to an operation 510. For example, if the first database management system 130 determines that an amount of borrowed resources required for fulfillment of the early access instruction is less than the current borrowed resource threshold, then the first database management system 130 may proceed to an operation 510.

In response to determining that the amount of borrowed resource required for fulfillment of the early access instruction is less than the current borrowed resource threshold, the first database management system 130 may, at the operation 510, fulfill the early access instruction. The first database management system 130 may fulfill the early access instruction by providing access to the amount of borrowed resources required for fulfillment of the early access instruction. For example, the first database management system 130 may effectively advance or loan the amount of borrowed resources required for fulfillment of the early access instruction to the first logical storage area. Notably, this advancement may occur without any involvement from third party systems such as, for example, the second database management system 140. Instead, the advancement is performed by the first database management system 130 operating independently of such systems. The advancement may, for example, transfer resources from an account owned by an object associated with the first database management system 130, such as an operator of such system, to the first logical storage area. A balance in the first logical storage area may be updated.

The fulfillment of the early access instruction enables a computing operation to be performed that could not be performed without such fulfillment. By way of example, it may be that the early access instruction enables a computing operation that requires mobile connectivity and the computing operation may be enabled by fulfilling the early access instruction so that the first logical storage area is associated with a sufficient data allocation to allow for the mobile connectivity required to complete the computing operation. In another example, it may be that the early access instruction enables a computing operation that requires a computing resource. In at least some such implementations, the early access instruction enables a computing operation that requires the computing resource. The computing operation may be enabled by fulfilling the early access instruction so that the first logical storage area is associated with a sufficient number of computing resources, which may be reflected in a balance, to allow for the computing resources required to complete the computing operation. In yet another example, it may be that the early access instruction enables a computing operation that requires a streaming resource. In at least some such implementations, the early access instruction enables a computing operation that requires the streaming resource. The computing operation may be enabled by fulfilling the early access instruction so that the first logical storage area is associated with a sufficient number of streaming resources, which may be reflected in a balance, to allow for the streaming resources required to complete the computing operation. In yet another example, it may be that the early access instruction enables a computing operation that requires an amount of stored value. For example, it may be that the computing operation is a transfer operation which transfers an amount of stored value to another account. The computing operation may be enabled by fulfilling the early access instruction so that the first logical storage area is associated with a sufficient amount of stored value, such as a sufficient amount of fiat or cryptocurrency, which may be reflected in a balance, to allow for the stored value required to complete the computing operation.

Accordingly, the advancement of a borrowed resource may enable completion of a computing operation that could not be performed without such advancement. In some implementations, the computing operation may be a computing operation that is defined in the early access instruction received at the operation 502.

After the early access instruction has been fulfilled, the first database management system 130 may, at an operation 512, monitor for a next regularly scheduled replenishment operation. Such monitoring may be performed by monitoring a balance in the first logical storage area and/or by monitoring incoming replenishment operations into the first logical storage area. By way of example, the first database management system 130 may monitor for an incoming transfer of resources that originated from a particular external account. For example, the first database management system 130 may monitor for a transfer of resources into the first logical storage area from the second logical storage area.

In at least some implementations, the monitoring may not begin immediately. Rather, the monitoring may be configured to occur at a determined time. The determined time may be a time that is within a defined proximity of a date of an expected next-regularly scheduled replenishment operation. The expected date of the next regularly-scheduled replenishment operation may be identified based on a frequency of past regularly-scheduled replenishment operations. That is, the date may be determined based on an amount of time between past regularly-scheduled replenishment operations. The monitoring may be configured to be performed at a time that is around the time of the next regularly-scheduled replenishment operation. For example, the monitoring may begin on the date of the expected next-regularly scheduled replenishment operation. Notably, delaying the monitoring may operate to conserve computing resources.

At an operation 514, the first database management system 130 may determine whether a next replenishment operation has occurred. In some instances, the first database management system 130 may determine that a next regularly scheduled replenishment operation was not performed as scheduled. For example, the first database management system 130 may monitor for expiry of a time period (at an operation 516) and, if the next regularly-scheduled replenishment operation is not detected before expiry of the time period, it may determine that the next regularly scheduled replenishment operation was not performed as scheduled. In response to determining that the next regularly scheduled replenishment operation was not performed as scheduled, the first database management system 130 may trigger an error operation 518. The error operation 518 may include generating a notification on a device associated with the first logical storage area. By way of example, a notification may be generated at the first device 108.

Reference will briefly be made to FIG. 7 which illustrates an example notification that may be generated at the operation 518. The notification is generated in an interface 700. The notification may include an indicator 710 indicating a nature of the error. For example, the indicator 710 may indicate that the next regularly scheduled replenishment operation was not performed as scheduled. The interface 700 may include a selectable option 720 to initiate a replenishment operation. Activation of the selectable option 720 may cause a replenishment operation to be performed. For example, activation of the selectable option 720 may cause a signal to be sent to the first database management system 130 and/or may cause an application on the first device 108 to be engaged and/or an operation on the first device 108 to be performed. Activation of the selectable option 720 may initiate a transfer of resources to the first logical storage area. The transfer of resources may be in an amount that is equal to or greater than the amount of the borrowed resources used in fulfilling the instruction at the operation 510. The amount of resources defined in the transfer may be automatically configured based on the amount of the borrowed resources used in fulfilling the instruction at the operation 510.

Referring again to FIG. 5, if, at the operation 514, the first database management system 130 detects a next replenishment operation, the first database management system 130 may, in response, perform a reversal operation to replenish the borrowed resources. Performing the reversal operation may include performing a data transfer associated with the first logical storage area. For example, a transfer out from the first logical storage area to another logical storage area may be performed. The transfer out may be to a logical storage area from which the borrowed resources were received at the operation 510. The amount of the transfer that is used in the reversal operation may be based on the amount of the borrowed resources used to fulfill the instruction at the operation 510. For example, the amount of the transfer may be the same as the amount of borrowed resources used. In some implementations, the amount of the transfer out at the reversal operation 520 may be more than the amount of the borrowed resources used at the operation 510. For example, performing the reversal operation may include applying an input output modifier during the reversal operation. The input output modifier may increase the amount of resources that are transferred at the operation 520 above those that were borrowed at the operation 510. The input output modifier may, in at least some implementations, be implemented using a mathematical operation such as a multiplication operation. In at least some implementations, the input output modifier may be applied together with a time parameter. The time parameter may represent an elapsed time period between the instruction being fulfilled at the operation 510 and the reversal being performed at the operation 520 and/or the replenishment being detected at the operation 514.

In some implementations and in some scenarios, it may be that the reversal operation is determined to be insufficient (at the operation 520). For example, the replenishment operation may be for an amount that is less than the amount required to complete the reversal operation in full. If the reversal operation is determined to be insufficient, then the first database management system 130 may trigger an error operation 524. The error operation 524 may be similar to the error operation 518. For example, an interface 700 of the type described above with reference to FIG. 7 may be output on the first device 108.

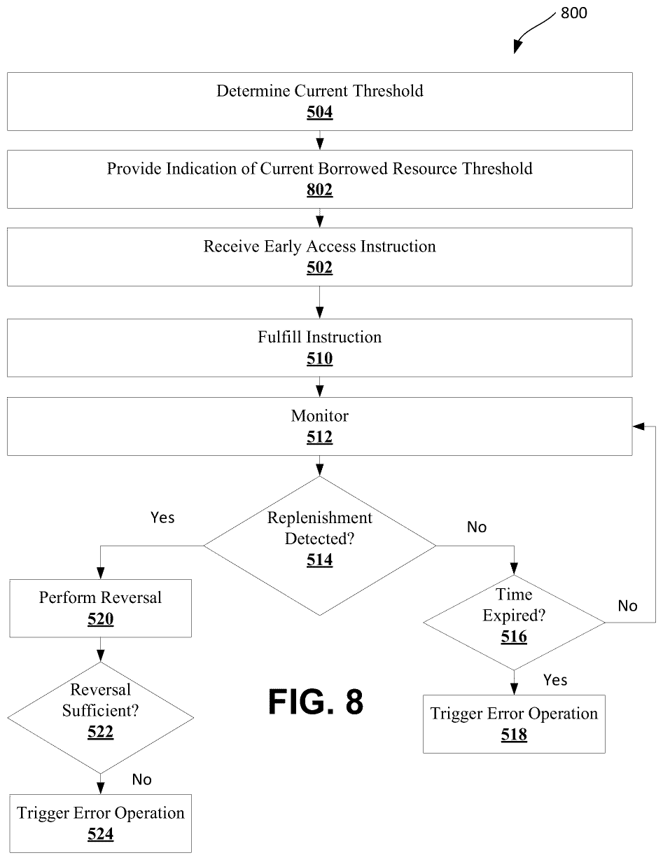

Reference will now be made to FIG. 8, which shows, in flowchart form, an example method 800 of providing early access to an accumulated resource. The method 800 may be implemented by a computing system such as the first database management system 130 of FIG. 1. For example, a software module may be configured to cause the first database management system 130 of FIG. 1 to implement the method 800. The method 800 may be performed, for example, by the processor 310 (FIG. 3) of a computing device 300 executing software comprising instructions such as may be stored in the memory 320 of the computing device 300. More particularly, processor-executable instructions may, when executed, configure a processor 310 of a computing system such as the first database management system 130 to perform all or parts of the method 800 or a portion thereof.

In performing the method 800, the first database management system 130 may cooperate with other systems and devices such as, for example, a first device 108 (FIG. 1) and/or a second database management system 140. Each of these devices may be configured with processor-executable instructions which cause such devices to perform methods which cooperate with the method 800. Accordingly, operations that are referred to below as being performed by the first device 108 may be included in a method which a processor of the first device 108 may perform. Similarly, operations that are referred to below as being performed by the first database management system 130 may be included in a method which a processor of the first database management system 130 may perform. Further, in performing such a method, the first database management system 130 may cooperate with the second device 110 and/or the second database management system 140 which may perform one or more other methods. Such methods may include any operations described herein as being performed by such devices. Further, it is contemplated that a method 800 may be performed by a system that includes two or more of the first database management system 130, the second database management system 140, the first device 108 and the second device 110, such that the method may include operations performed by multiple devices.

The method 800 of FIG. 8 includes a number of operations in common with the method 500 of FIG. 5. For the sake of readability, the discussion of such operations will not be repeated but like operations are indicated by like reference numerals.

The method 800 of FIG. 8 differs from the method 500 of FIG. 5 in that the ordering of the operations 502 and 504 are reversed. In the method 800 of FIG. 8, the current borrowed resource threshold is first determined at the operation 504. This may be performed in the same or a similar manner to the operation 504 discussed above with reference to the method 500 of FIG. 5.

Next, at an operation 802, the first database management system 130 may provide, at a device associated with the first logical storage area, an indication of the current borrowed resource threshold for display in an interface. By way of example, the first database management system 130 may provide the indication of the current borrowed resource threshold to the first device 108.

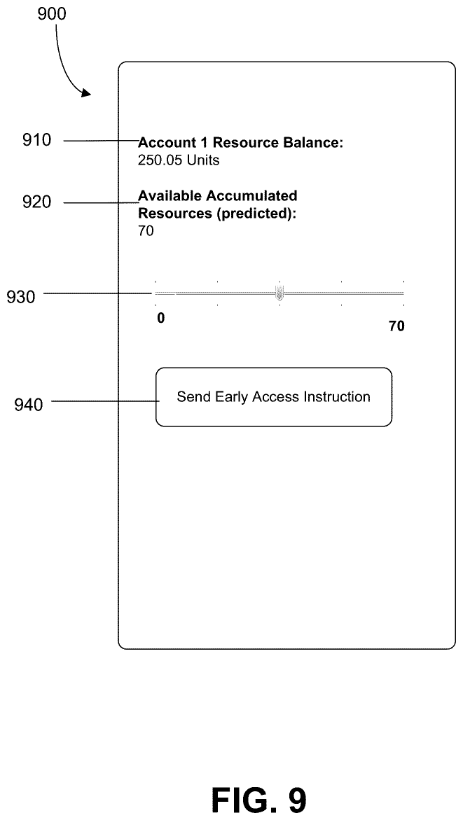

For example, referring briefly to FIG. 9, at interface 900 may be displayed on the first device 108. The interface 900 may include an indicator 910 of a balance of resources in a first logical storage area. The interface 900 may include an indicator 920 of the current borrowed resource threshold determined at the operation 504. The interface 900 may include one or more interface elements for inputting an early access instruction. For example, the interface 900 of FIG. 9 includes an interface element 930 for inputting an amount of borrowed resources that are to be accessed. The interface element 930 is, in the example, a slider interface element.

The interface elements for inputting the early access instruction may include a button 940 or other interface element for causing the early access instruction to be sent to the first database management system 130.

As illustrated in FIG. 9, the early access instruction may be sent to and received at the first database management system 130 when the current borrowed resource threshold is displayed in the interface 900.

Referring again to FIG. 8, the early access instruction may be received at the first database management system 130 at an operation 502. This operation 502 may be the same or similar to the operation 502 referred to above with reference to FIG. 5. The early access instruction may be received via the interface 900. For example, the early access instruction may be received with the slider interface element 930.

Following the receipt of the early access instruction, the early access instruction may be fulfilled at the operation 510. The method 800 may then include one or more of the operations 514, 516, 518, 520, 522, 524 of the method 500 of FIG. 5.

In at least some implementations, one or more of the methods described above or a variation thereof may be used to provide dynamic accumulated resource access threshold selection. Such an example will now be described.

Earned wage access platforms allow employees to access wages that they have earned but not yet been paid. For example, employees may access a portion of wages prior to a scheduled payroll date. Earned wage access platforms may only allow customers to access up to a threshold amount of their earned wages. For example, a threshold may be 60%. This threshold is in place to help to ensure that a customer has sufficient leftover pay at pay day. This 60% threshold may be appropriate for some customers, but it is not appropriate for all customers. For example, it may be that a customer is mortgage-free and they do not need to set aside as much of their paycheck as other customers who have rent or mortgage payments that need to be paid. Also, the 60% threshold may not be appropriate since some customers are paid more than others.

A solution to the problem of fixed earned wage access limits is to determine a customer-specific threshold which will be used to restrict how much earned wages a particular customer is permitted to access. An earned wage access platform may allow a customer or employee to access only a portion of their earned wages and the portion that a particular customer/employee has access to varies from employee to employee. An employee-specific threshold may be defined for a user and that threshold will control the portion of that user's wages that may be accessed early.

The threshold may be an absolute or relative value such as dollars or a percentage. For example, one user may have a threshold of 50%, allowing them to access 50% of earned wages early and another user may have a threshold of 60%, allowing them to access 60% of earned wages early. In another example, one user may be permitted to access $100 of earned wages early and another $200. The threshold may, in some instances represent the amount of pay that may be accessed and in other instances represent the amount of pay that is to be retained until pay day.

The threshold may be determined using a transaction history for the customer's account. In some implementations, the earned wage access platform may be provided by a customer's bank and so that bank may determine the threshold that controls earned wage access for a particular customer based on that customer's transaction history. In some situations, the earned wage access platform may not be provided by the customer's bank but it may nevertheless have access to the customer's banking transaction history using open banking techniques. For example, all customers may first be setup with a fixed threshold which is designed to be low for all customers and, if they wish to have access to a greater portion of earned wages (e.g., if they wish to increase the threshold), they may be required to grant the earned wage access platform with access to their data (e.g., grant them an access token) so that the earned wage access platform may evaluate their transaction history in order to determine eligibility for a greater threshold.

The transaction history of a customer may be used in various ways in order to determine an appropriate threshold for that customer. For example, in some implementations, a system may identify all expected non-discretionary expenses that a customer will need to pay using funds from a current pay cycle and it may define the threshold to set aside at least an amount of funds that is sufficient to pay the non-discretionary expenses. Non-discretionary expenses may include rent, mortgage, utility payments, tax payments, etc. In some instances, subscription fees such as Netflix, Amazon, etc. may be treated as non-discretionary. For example, any payment that must be made at some periodic interval may be treated as non-discretionary in some implementations.

The threshold may be determined using a rules-based approach or based on artificial intelligence or machine learning. Where an AI/machine learning approach is used, the system may train the AI/machine based on data about customers that have fallen short of funds in the past.

The threshold may also, in some instances, be determined based on credit risk. For example, customers with better credit may have a greater threshold than customers with a lesser threshold.

In some instances, the threshold may be determined, at least in part, by performing an automated cash-flow analysis for a particular customer. The cash-flow analysis may use prediction techniques to determine whether the particular customer will likely fall short of funds if funds are advanced too soon.

In some instances, a customer may indicate, to the system, whether the funds are to be advanced for a discretionary or non-discretionary purpose. If the funds are advanced for a non-discretionary purpose (such as a mortgage payment), then the threshold may not apply or a different threshold may be used that would be used for discretionary purposes. In some instances, the system may not advance the funds directly to the customer but may instead process a payment on behalf of the customer to another party. In this way, the platform may ensure that the customer is not inputting a falsified purpose; the platform can vet the purpose based on the transferee. For example, if the transfer is made to a utility company, it may be concluded that it is a non-discretionary transfer but if it is made to a sporting goods store, it may be concluded that it is discretionary.

In some instances, the threshold may be determined based on a balance in an account. For example, the system may, when deciding whether funds should be advanced, consider whether the customer's account already has funds.

It will be understood that, using the techniques described herein, different customers may have different earned wage access. Some example scenarios in which a customer may access a greater or lesser amount will now be discussed.

In one example, scenario, all else being equal, a customer having no mortgage or rent payment coming due after payday may access a greater amount of earned wages than a customer having a mortgage or rent payment coming due after payday.

In another example scenario, all else being equal, a customer having a mortgage or rent payment coming due before pay day may access a greater amount of earned wages than a customer having no such payments due before payday if the customer is using the advance to pay the mortgage or rent payment and if the customer would not otherwise have sufficient funds to make the payment.

In another example scenario, all else being equal, a customer with a better credit history may access a greater portion of earned wages than a customer with a bad credit history.

Conveniently, in this way, a system may tailor a threshold that controls accumulated resource access to a particular customer based on the customer's transaction history or other factors. The system may be a system of the type described herein.

In some implementations, one or more of the method 500, 800 described herein may be used to provide access to a borrowed resource based on an expected accumulation of resources.

For example, another problem with traditional earned wage access platforms is that they typically require employer buy-in. That is, they only operate for employers that work with a service provider to provide earned wage access. Also, they require integration between various computing systems such as payroll and time keeping systems which can act as an impediment to adoption. It may be difficult to configure such computing systems to interact with one another. Earned wage access is typically only provided by very large employers that can accept the computing and system integration burdens that come with such systems.

In some implementations, a solution to such computing problems may involve an earned wage access system that may operate without any employer participation. More specifically, the earned wage access system may be provided to a customer upon request of the customer. In order to participate in earned wage access, a customer may send a request to participate to a system. The system may be, for example, a banking system associated with the customer's account. When the system receives the request, the system may automatically evaluate the customer. The evaluation may consider, for example, the credit-worthiness of the customer. Based on the credit-worthiness of the customer, the system may define a threshold that will be used for the customer for earned wage access. The threshold may be based, in part, on the customer's salary.

In some implementations, the customer may also be required to configure their payroll to be directed to an account associated with the system. Alternatively, the customer may be required to provide pre-authorized debit consent to the system to allow the system to pull funds from the customer's bank account on payday.

After a customer has setup earned wage access directly with the system, the customer may view the status of earned wages available together with other account information. For example, a user interface, an example of which is illustrated in the drawings, may display the amount of earned wages available at any point in time together with other account information, such as bank balance information or credit limit data. The user interface may allow the customer to transfer the earned wages or a portion of the earned wages directly into another account.

The earned wages may be visible together with more traditional bank account data. In this way, the customer can see a better snapshot of their current financial status.

The earned wage access may be provided on a fee-based or interest-based model. For example, a modifier may be applied to the customer's account which may reduce the amount of pay that the customer receives on pay day on account of this fee or interest.

When a customer transfers money from their earned wage account to another account, the system may then monitor for the customer's pay date. When the pay date arrives, the system may automatically transfer a portion of the pay to offset the earned wages advanced.

In some instances, the customer's wage on pay date is less that what was advanced. (e.g. they quit the job or worked less). In such cases, any difference will become an unsecured loan that has a previously approved rate payable on a due date.

The threshold that controls how much the customer is able to withdraw from their earned wages account may vary over time. For example, the system may automatically detect a raise and may adjust the threshold to account for the raise.

In yet another example, one or more of the methods 500, 800 described herein or a variation thereof, may provide accumulated resource access based on a projected amount. As noted above, another problem with traditional earned wage access platforms is that they typically require employer buy-in. That is, they only operate for employers that work with a service provider to provide earned wage access. Also, they require integration between various computing systems such as payroll and time keeping systems which can act as an impediment to adoption. Earned wage access is typically only provided by very large employers that can accept the computing and system integration burdens that come with such systems.

In at least some implementations, a system may be configured to implement earned wage access without requiring integration with an employer's payroll and time tracking system. Rather, an employer may provide, to the system, information about an employee's wages, typical working days and hours, and the system may then predict the available earned wages at any given time and advance earned wages based on the predicted amount.

For example, an employer may provide a list of employees including identifying information of such employees, and associated salaries and typical working days and hours and the system may use this information to allow the listed employees to tap into their earned wages. In some implementations, the employer may provide such a list through a management interface associated with the system.

The system may allow employees that are defined by the employer to enroll for the earned wage access service. The employee enrolls by providing the system with access to the employee's pay. This may be done in various ways. For example, in one implementation, the employee may change their directed deposit information so that their payroll is sent to an account associated with the system rather than the employee's own account. The system will then deduct any wages previously advanced from the payroll and will then send the remainder to the employee's account. If the employee is paid less than the amount already advanced, then they will be charged for the difference. The outstanding amount may be converted to a loan.

In some implementations, the employee may not be required to direct their payroll to the service provider's account (i.e., to an account associated with the earned wage access system). Rather, the employee may provide the system with access to the employee's bank account. For example, the employee may enable pre-authorized debit. Then, after a scheduled pay day, the system may pull any advanced wages from the employee's account. In some implementations, the service provider system may use real time payments for instant transfer of funds. In at least some such implementations, the advanced wages may be treated as a loan. If, for any reason, the service provider is unable to pull the required funds, then the advanced wages may be continued to be treated as a loan and the employee may incur interest charges.

In yet another example, one or more of the methods 500, 800 described herein or a variation thereof, may provide an earned wage access platform of the following type. A platform may be provided at a system, such as the first database management system 130. The platform may include one or more of the following features. The platform may provide a Consumer Earned Wage Access (CEWA) product. The earned wage access product may not rely on a provider working with an employer. Instead, the first database management system 130 may provide a product that simulates or emulates earned wage access.

The system may determine eligibility based on account history and salary direct deposit data (if any). Salary direct deposit data, if available, may also be shared with a selected payroll account access system for additional eligibility checks. Eligible customers may be shown a link to enroll within online and mobile banking when the customer accesses their demand deposit account (DDA). The system may place enrollment links at other places within online and mobile banking.

Eligible users may be provided access to their earned wages. Customers may be initially made to go through registration where they may need to accept terms and conditions and link their payroll and time tracking (if available) accounts. Whether or not the system gets their salary direct deposit today, users may still need to update direct deposit information at the employer as described below. The system may leverage a payroll account access vendor to obtain access to and update the payroll account. Upon successful enrollment a line of credit may be established by the system based on customer salary and account data. The system may also allow the payroll account access vendor to provide its recommendation on the credit limit but the system may choose to adjust this recommendation based on additional account data. This credit limit may be revisited periodically (e.g., every month) based on salary data.

There are various options for updating direct deposit. In a first option, the payroll account access vendor on behalf of the system may open an omnibus account at the system or another bank or system that supports omnibus accounts and may create virtual accounts within that for each enrolled customer. The customer's payroll account may be updated by the payroll account access vendor to start sending the salary to the virtual account at the system set up by them.

In a second option, the payroll account access vendor may update the direct deposit at the employer to start sending all wages to the customer's account at the system.

Once the customer is successfully enrolled, whenever they visit the DDA page they may be shown how much they have earned for the current pay period and how much they can withdraw. This is a floating loan where available amount of loan changes based on the amount of earned wages available. For example, the floating loan may be updated on a daily basis. The maximum loan amount may not be based on the credit limit. The possible loan amount will always be lower than the credit limit that was established based on how money they have earned. Earned wages may be determined based on data that the system can see in the payroll systems and in some cases for hourly employees the system may also have access to time tracking system to see how many hours they have worked.

A customer can specify any amount up to the total available earned wage amount that they would like to withdraw. Once a user confirms the amount they may be taken to a summary page where the will be shown that withdrawal amount along with the fee that will be charged. The system may or may not charge a fee for withdrawing earned wages. The system may display additional information related to similar loans display on the summary page since this will be a loan which can include annual percentage rate (APR), terms and conditions, etc. Terms and conditions may also show fee or interest that might be charged if the customers salary is not received by the system or is a lower amount that what they withdrew.

Once the customer confirms the amount they want to withdraw, the system may transfer resources to them from the line of credit to their DDA. The payroll account access vendor may be informed about the same. The system may use an internal book transfer or real time payment rails for transferring the funds to customer's DDA account. From this point onwards until the end of pay period the Earned Wage availability amount will be adjusted to reflect the withdrawn amount. The customer may be allowed to make additional withdrawals up to earned wage availability amount but, in at least some implementations, no more than a defined number of withdrawals per month. The system may also have the option to limit use of earned wages based on various criteria.

Salary deposit may be handled in various ways. In a first option, on the pay date the salary may now come to a virtual account set up for the customer. The system may first pay off the line of credit and then send rest of the funds to the customers DDA account. All balances may be accordingly updated.

In a second option, on the pay date the salary will come to customer's DDA account. When the system receives direct deposit instructions it may pay off the line of credit at the same time that it adds the direct deposit to the customer's DDA account.

If no salary is received or if the customer's salary is less than the advanced amount, then they will no longer be able to withdraw funds from the earned wage platform. This can also happen if the system no longer has access to the customer payroll system and it can't validate if the salary is still being sent to the system's virtual account. The customer will be shown the amount they need to pay the system and given options to transfer from an internal account (including the DDA) or from an external account. The system may provide a grace period for the customer to pay the amount and/or charge them additional interest rate/fee.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computing system comprising:
a communications module;
a processor coupled to the communications module; and
a memory coupled to the processor storing instructions that, when executed by the computing system, cause the computing system to:
receive an early access instruction associated with a first logical storage area, the early access instruction requesting early access to at least a portion of resources associated with a next regularly scheduled replenishment operation;
determine a current borrowed resource threshold based on a measure of an amount of the next regularly scheduled replenishment operation attributable to a time period that began on a last regularly scheduled replenishment operation and ended at a current time;
determine that an amount of borrowed resources required for fulfillment of the early access instruction is less than the current borrowed resource threshold; and
in response to determining that the amount of borrowed resource required for fulfillment of the early access instruction is less than the current borrowed resource threshold, fulfill the early access instruction by providing access to the amount of borrowed resources, wherein fulfillment of the early access instruction enables a computing operation to be performed that could not be performed without such fulfillment.

2. The computing system of claim 1, wherein the instructions further cause the computing system to:
monitor for the next regularly scheduled replenishment operation; and
in response to detecting the next regularly scheduled replenishment operation, perform a reversal operation to replenish the borrowed resources.

3. The computing system of claim 2, wherein performing the reversal operation includes performing a data transfer associated with the first logical storage area.

4. The computing system of claim 2, wherein performing the reversal operation includes applying an input output modifier during the reversal operation.

5. The computing system of claim 1, wherein the instructions further cause the computing system to:
monitor for the next regularly scheduled replenishment operation;
determine that a next regularly scheduled replenishment operation was not performed as scheduled; and
in response to determining that the next regularly scheduled replenishment operation was not performed as scheduled, generate a notification on a device associated with the first logical storage area.

6. The computing system of claim 5, wherein the notification includes a selectable option to initiate a replenishment operation.

7. The computing system of claim 1, wherein the current borrowed resource threshold is further determined based on past resource access requests.

8. The computing system of claim 1, wherein the current borrowed resource threshold is further determined by applying a modifier to the measure of an amount of the next regularly scheduled replenishment operation attributable to a time period that began on a last regularly scheduled replenishment operation and ended at a current time, the modifier reducing the current borrowed resource threshold.

9. The computing system of claim 1, wherein the instructions further cause the computing system to:
provide, at a device associated with the first logical storage area, an indication of the current borrowed resource threshold for display in an interface.

10. The computing system of claim 9, wherein the early access instruction is received via the interface when the current borrowed resource threshold is displayed in the interface.

11. The computing system of claim 10, wherein the early access instruction is received via a slider interface element.

12. A computer-implemented method comprising:
receiving an early access instruction associated with a first logical storage area, the early access instruction requesting early access to at least a portion of resources associated with a next regularly scheduled replenishment operation;
determining a current borrowed resource threshold based on a measure of an amount of the next regularly scheduled replenishment operation attributable to a time period that began on a last regularly scheduled replenishment operation and ended at a current time;
determining that an amount of borrowed resources required for fulfillment of the early access instruction is less than the current borrowed resource threshold; and
in response to determining that the amount of borrowed resource required for fulfillment of the early access instruction is less than the current borrowed resource threshold, fulfilling the early access instruction by providing access to the amount of borrowed resources, wherein fulfillment of the early access instruction enables a computing operation to be performed that could not be performed without such fulfillment.

13. The method of claim 12, further comprising:
monitoring for the next regularly scheduled replenishment operation; and
in response to detecting the next regularly scheduled replenishment operation, performing a reversal operation to replenish the borrowed resources.

14. The method of claim 13, wherein performing the reversal operation includes performing a data transfer associated with the first logical storage area.

15. The method of claim 13, wherein performing the reversal operation includes applying an input output modifier during the reversal operation.

16. The method of claim 12, further comprising:
monitoring for the next regularly scheduled replenishment operation;
determining that a next regularly scheduled replenishment operation was not performed as scheduled; and
in response to determining that the next regularly scheduled replenishment operation was not performed as scheduled, generating a notification on a device associated with the first logical storage area.

17. The method of claim 16, wherein the notification includes a selectable option to initiate a replenishment operation.

18. The method of claim 12, wherein the current borrowed resource threshold is further determined based on past resource access requests.

19. The method of claim 12, wherein the current borrowed resource threshold is further determined by applying a modifier to the measure of an amount of the next regularly scheduled replenishment operation attributable to a time period that began on a last regularly scheduled replenishment operation and ended at a current time, the modifier reducing the current borrowed resource threshold.

20. The method of claim 12, further comprising:
providing, at a device associated with the first logical storage area, an indication of the current borrowed resource threshold for display in an interface.
